(19) United States
(12) Patent Application Publication
(10) Pub. No.: US 2018/0174217 A1
(43) Pub. Date: Jun. 21, 2018

(54) INTERMEDIATE SUPPORT SYSTEM, INTERMEDIATE SUPPORT METHOD, AND NON-TRANSITORY COMPUTER READABLE STORAGE MEDIUM

(71) Applicant: YAHOO JAPAN CORPORATION, Tokyo (JP)

(72) Inventor: Takamitsu IRIYAMA, Tokyo (JP)

(73) Assignee: YAHOO JAPAN CORPORATION, Tokyo (JP)

(21) Appl. No.: 15/835,143

(22) Filed: Dec. 7, 2017

(30) Foreign Application Priority Data
Dec. 20, 2016 (JP) 2016-246756

(51) Int. Cl. G06Q 30/06; G06Q 10/10

(52) U.S. Cl. CPC G06Q 30/0617; H04W 4/02; G06Q 10/1093; G06Q 30/0633

(57) ABSTRACT

An intermediate support system includes a receiving unit that receives, from a first user, a purchase request for a product or a service sold in a store; a user extracting unit that extracts a second user who is at least one of a user who is currently visiting the store and a user who is highly likely to visit the store; and an intermediating unit that sends, based on the purchase request received by the receiving unit, to a terminal device that is used by the second user extracted by the user extracting unit, information that requests to purchase the product or the service.

### CROSS-REFERENCE TO RELATED APPLICATION(S)

The present application claims priority to and incorporates by reference the entire contents of Japanese Patent Application No. 2016-246756 filed in Japan on Dec. 20, 2016.

### BACKGROUND OF THE INVENTION

### 1. Field of the Invention

The present invention relates to an intermediate support system, an intermediate support method, and an intermediate support program.

### 2. Description of the Related Art

There is a known shopping agency-service support system in which a store supports a shopping agency service in which a shopping requester requests a shopping agency-service representative to do shopping at a store (see Japanese Laid-open Patent Publication No. 2013-182527). In this shopping agency-service support system, a store receives a predetermined usage fee of the shopping agency service, which is previously determined by the store as the usage fee to be paid for the shopping agency service by the shopping requester, from a shopping agency-service representative and pays the usage fee of the shopping agency service to the agency-service representative.

In a conventional technology, because a shopping requester requests, in the home of the shopping requester, a shopping agency-service representative to do shopping and then the shopping agency-service representative delivers products to the shopping requester, the load applied to the shopping agency-service representative is sometimes increased.

### SUMMARY OF THE INVENTION

It is an object of the present invention to at least partially solve the problems in the conventional technology.

An intermediate support system includes a receiving unit that receives, from a first user, a purchase request for a product or a service sold in a store, a user extracting unit that extracts a second user who is at least one of a user who are currently visiting the store and a user who is highly likely to visit the store; and an intermediating unit that sends, based on the purchase request received by the receiving unit, to a terminal device used by the second user extracted by the user extracting unit, information that requests to purchase the product or the service.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a store support system 1 according to an embodiment;

FIG. 2 is a diagram illustrating the configuration of a user terminal device 100 according to the embodiment;

FIG. 3 is a diagram illustrating the configuration of a store server 200 according to the embodiment;

FIG. 4 is a diagram illustrating the configuration of a store support server 300 according to the embodiment;

FIG. 5 is a diagram illustrating the configuration of an intermediate server 400 according to the embodiment;

FIG. 6 is a diagram illustrating an example of a store database 500a according to the embodiment;

FIG. 7 is a diagram illustrating an example of a number-of-visitors database 500b according to the embodiment;

FIG. 8 is a diagram illustrating an example of a product-or-the-like database 500c according to the embodiment;

FIG. 9 is a diagram illustrating an example of a sale database 510 according to the embodiment;

FIG. 10 is a diagram illustrating an example of a product-or-the-like purchase database 520 according to the embodiment;

FIG. 11 is a diagram illustrating an example of an agency-service request database 530 according to the embodiment;

FIG. 12 is a diagram illustrating an example of an agency-service record database 540 according to the embodiment;

FIG. 13 is a flowchart illustrating the flow of a sale automatic setting process performed in the store support system 1 according to the embodiment;

FIG. 14 is a diagram illustrating a process of setting a sale period performed by the store support server 300;

FIG. 15 is a diagram illustrating a process of extracting users;

FIG. 16A is a diagram illustrating an example of content 340a provided by the user terminal device 100;

FIG. 16B is a diagram illustrating an example of content 340b provided by a store terminal device 230;

FIG. 17 is a flowchart illustrating the flow of a sale automatic start process performed in the store support system 1 according to the embodiment;

FIG. 18 is a diagram illustrating a relationship between the location of a store and the location of a user;

FIG. 19 is a flowchart illustrating the flow of a process of providing remaining quantity information performed in the store support system 1 according to the embodiment;

FIG. 20 is a diagram illustrating an example of a process of estimating a remaining quantity of products or the like;

FIG. 21 is a diagram illustrating an example of another process of estimating the remaining quantity of the products or the like;

FIG. 22 is a flowchart illustrating the flow of a stock inquiry process and an agency-service request process;

FIG. 23A is a diagram illustrating an example of content 340c;

FIG. 23B is a diagram illustrating an example of content 340d used to reply to a stock inquiry;

FIG. 23C is a diagram illustrating an example of content 340e indicating the result of the stock inquiry;

FIG. 23D is a diagram illustrating an example of content 340f providing a request for a shopping agency service;

FIG. 23E is a diagram illustrating an example of content 340g used to send a reply indicating that a product or the like has been received from an agency-service representative;

FIG. 24 is a flowchart illustrating an example of the flow of the agency-service request process;

FIG. 25 is a diagram illustrating the configuration of the store support system 1 according to a modification; and

FIG. 26 is a diagram illustrating an example of hardware configuration of the user terminal device 100, the store server 200, the store support server 300, the intermediate server 400, and a database server 500.

### DETAILED DESCRIPTION OF THE PREFERRED EMBODIMENTS

In the following, preferred embodiments of an intermediate support system, an intermediate support method, and an intermediate support program according to the embodiments will be described with reference to the accompanying drawings.

1. Outline

In the intermediate support system according to the embodiment, a first user sends, based on a receiving unit that receives a purchase request for a product or a service sold in a store (hereinafter, referred to as the product or the like) and based on a user extracting unit that extracts a second user who is at least one of a user who is currently visiting the store and a user who is highly likely to visit the store, and based on the purchase request, information that requests to purchase the product or the like to a terminal device that is used by the second user. The first user is, for example, a requester who requests a shopping agency service. The second user is a person, for example, who may possibly perform a shopping agency service in accordance with a request for the shopping agency service.

The intermediate support system according to the embodiment can exhibit an advantage in that, because at least one of the user who is currently visiting the store and the user who is highly likely to visit the store is extracted as the second user, it is possible to reduce the burden placed on the second users to move to the store in order to provide a shopping agency service.

2. Configuration of the Store Support System 1

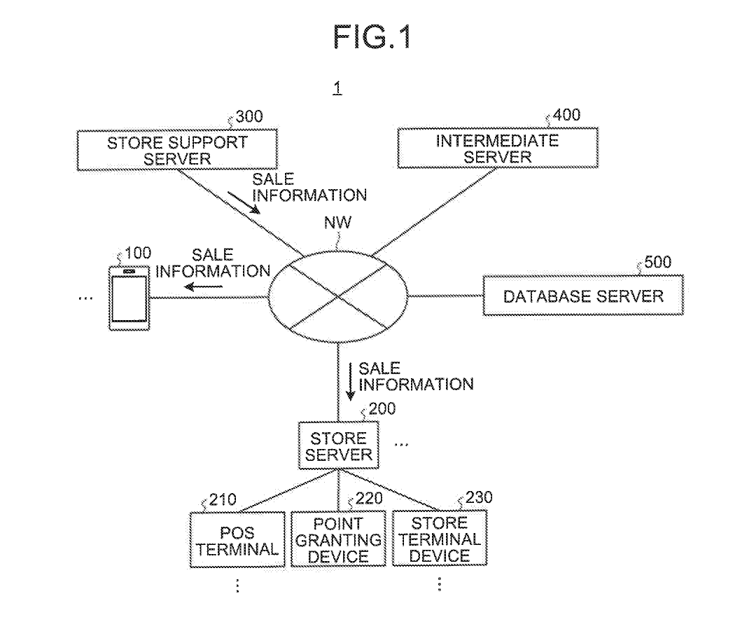

FIG. 1 is a diagram illustrating an example of the store support system 1 according to the embodiment. The store support system 1 includes, for example, one or more of the user terminal devices 100, one or more of the store servers 200, a store support server 300, and an intermediate server 400, and a database server 500. In the store support system 1, the user terminal device 100, the store server 200, the store support server 300, the intermediate server 400, and the database server 500 are connected to the network NW. Each of the devices connected to the network NW includes a communication interface, such as a network interface card (NIC) or a wireless communication module (not illustrated in FIG. 1). The network NW includes, for example, wireless base stations, Wi-Fi access points, communication lines, providers, the Internet, or the like.

All of the combinations of these components do not always need to be capable of communicating with each other and the network NW may also include a local network in some portion. Furthermore, a part or all of the store support server 300, the intermediate server 400, and the database server 500 may also be integrated into a single device.

2-1. Configuration of the User Terminal Device 100

The user terminal device 100 is a device used by a user (public user). The user terminal device 100 is, for example, a mobile phone, such as a smart phone or a computer device (communication device), such as a tablet terminal, a personal computer. In the user terminal device 100, for example, a sale notification application for receiving a sale notification service provided by the store support server 300 and an intermediate application for receiving an intermediate service provided by the intermediate server 400 are installed. Each of the application programs sends, in response to a predetermined operation, a request that requests content to the store support server 300 or the intermediate server 400. Furthermore, each of the application programs receives a push notification sent from the store support server 300 or the intermediate server 400 and outputs an image or a voice to the user terminal device 100. Furthermore, a part of the function of the application programs may be replaced with a web browser. In this case, a web browser sends a Hypertext Transfer Protocol (HTTP) request to the store support server 300 or the intermediate server 400. Then, the store support server 300 creates a web screen based on the web page returned from the intermediate server 400 and displays the web screen on the displaying unit. The web page is content including, for example, text data described in a markup language, such as Hyper Text Markup Language (HTML), style sheets, still image data, moving image data, audio data, or the like.

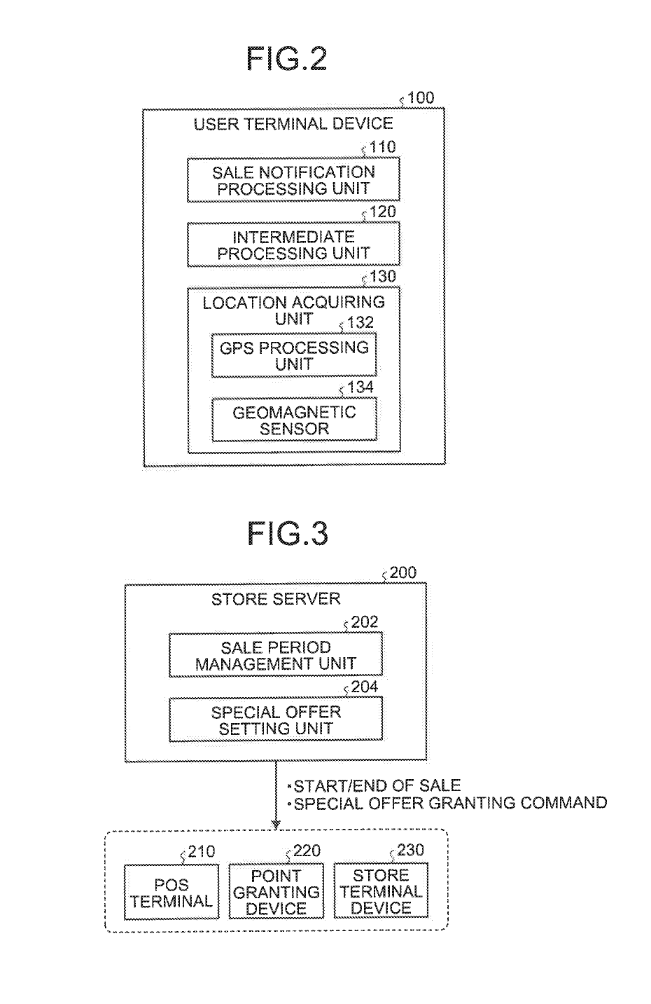

FIG. 2 is a diagram illustrating the configuration of the user terminal device 100 according to the embodiment. The user terminal device 100 includes, for example, a sale notification processing unit 110, an intermediate processing unit 120, and a location acquiring unit 130. These functioning units are implemented by, for example, a processor, such as a central processing unit (CPU), executing a program stored in a program memory. Furthermore, a part or all of the functioning units may also be implemented by hardware, such as a large scale integration (LSI), an application specific integrated circuit (ASIC), or a field-programmable gate array (FPGA), or, may also alternatively be implemented by software and hardware in cooperation with each other.

The sale notification processing unit 110 is implemented by executing the sale notification application. The sale notification processing unit 110 controls the displaying unit, a speaker, or the like based on sale information provided from the store support server 300 and notifies users of a sale. The intermediate processing unit 120 is implemented by executing the intermediate application. The intermediate processing unit 120 provides an intermediate service to the users in cooperation with the intermediate server 400. The location acquiring unit 130 includes, for example, a GPS processing unit 132 and a geomagnetic sensor 134. The GPS processing unit 132 specifies the location of the user terminal device 100 based on the signal received from a global navigation satellite system (GNSS) satellite. The geomagnetic sensor 134 detects geomagnetic patterns around the user terminal device 100. The location acquiring unit 130 specifies the location of the user terminal device 100 based on the detected geomagnetic pattern.

2-2. Configuration of the Store Server 200, Etc.

The store server 200 performs a process of supporting the execution of a sale based on the sale information acquired from the store support server 300. The store server 200 is connected to, as illustrated in FIG. 1, one or more point of sale (POS) terminals 210, a point granting device 220, and a store terminal device 230. The store support servers 300, the POS terminals 210, the point granting device 220, and the store terminal device 230 are connected by, for example, a local network in the store so as to be capable of communicating with each other.

The point of sale (POS) terminal 210 is a computer device that includes an operation interface, a NIC, or the like and that is used by a clerk in the store. The POS terminal 210 is operated by the clerk and receives an order of a product. The POS terminal 210 creates order data including the product name and the quantity of the ordered product and performs a settlement process on a product or the like. The POS terminal 210 grants a special offer based on the sale information in the settlement process of the product or the like. The point granting device 220 is a computer device operated by a clerk or a user. The point granting device 220 grants a point as the special offer based on the received operation. Furthermore, the point granting device 220 may also be integrated with the POS terminal 210 as a single unit. The store terminal device 230 is a computer device used by a clerk. The store terminal device 230 performs a process of exhibiting the content of the sale to the clerk based on the sale information acquired from the store support server 300.

FIG. 3 is a diagram illustrating the configuration of the store server 200 according to the embodiment. The store server 200 includes, for example, a sale period management unit 202 and a special offer setting unit 204. These functioning units are implemented by, for example, a processor, such as a CPU, executing the program stored in a program memory. The sale period management unit 202 controls the start and the end of the sale period. If a predetermined condition is satisfied in the sale period, the special offer setting unit 204 sends an instruction to grant the special offer to the POS terminal 210 and the point granting device 220.

2-3. Configuration of the Store Support Server 300

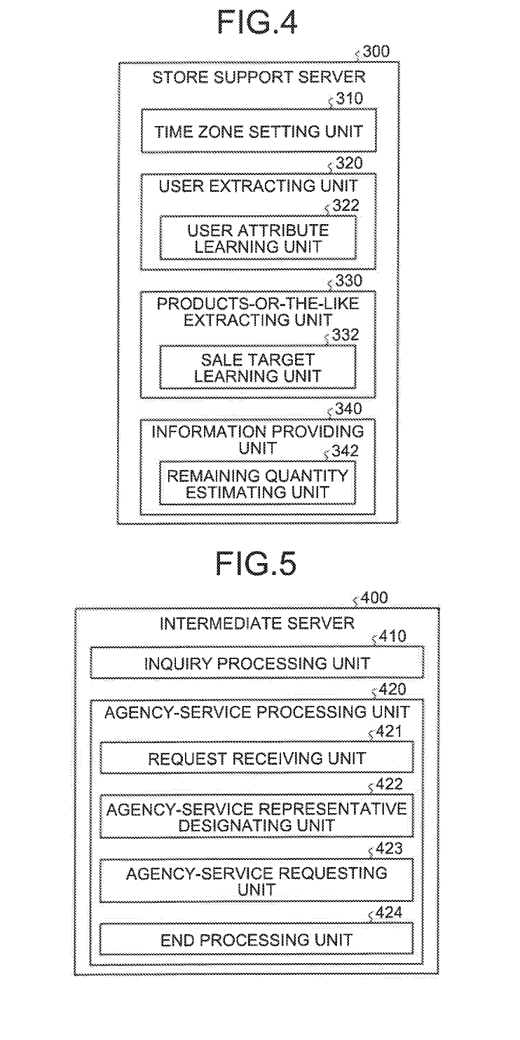

FIG. 4 is a diagram illustrating the configuration of the store support server 300 according to the embodiment. The store support server 300 is a server device that provides a sale notification service. The store support server 300 includes, for example, a time zone setting unit 310, a user extracting unit 320, a product-or-the-like extracting unit 330, and an information providing unit 340. These functioning units are implemented by, for example, a processor, such as a CPU, executing the program stored in a program memory.

The time zone setting unit 310 sets a time zone in which a sale is performed. The time zone setting unit 310 automatically sets the time zone in accordance with, for example, the predetermined rule. The predetermined rule mentioned here is to select the time zone in which the number of visitors is lower than the criteria. Furthermore, the time zone setting unit 310 may also set the time zone based on the operation performed in the store terminal device 230. The user extracting unit 320 extracts users who are highly likely to visit the store in the time zone set by the time zone setting unit 310. The user extracting unit 320 may also include a user attribute learning unit 322 that learns, based on the attributes of the users, the users to be extracted. The product-or-the-like extracting unit 330 extracts, based on the purchase attribute of each of the users with respect to the products or the like, the products or the like targeted for granting the special offer. The product-or-the-like extracting unit 330 may also include a sale target learning unit 322 that learns a sale target. The information providing unit 340 creates the sale information in which the time zone, the products, and the like are designated. The information providing unit 340 sends the created sale information to the store server 200 and the user terminal devices 100 that are used by the users extracted by the user extracting unit 320.

2-4. Configuration of the Intermediate Server 400

FIG. 5 is a diagram illustrating the configuration of the intermediate server 400 according to the embodiment. The intermediate server 400 includes, for example, an inquiry processing unit 410 and an agency-service processing unit 420. These functioning units are implemented by, for example, a processor, such as a CPU, executing the program in a program memory. The inquiry processing unit 410 sends, as a reply, a response including the remaining amount of the products or the like to the user terminal device 100 based on the inquiry request received from the user terminal device 100. The agency-service processing unit 420 includes, for example, a request receiving unit 421, an agency-service representative designating unit 422, an agency-service requesting unit 423, and an end processing unit 424. The request receiving unit 421 receives an agency-service request from the user terminal device 100 operated by a user who requests a shopping agency service. The agency-service representative designating unit 422 designates an agency-service representative who does shopping on behalf of the user. The agency-service requesting unit 423 requests the agency-service representative to provide a shopping agency service. The end processing unit 424 manages the compensation for delivery of the products or the like to the requester by the agency-service representative.

2-5. Database

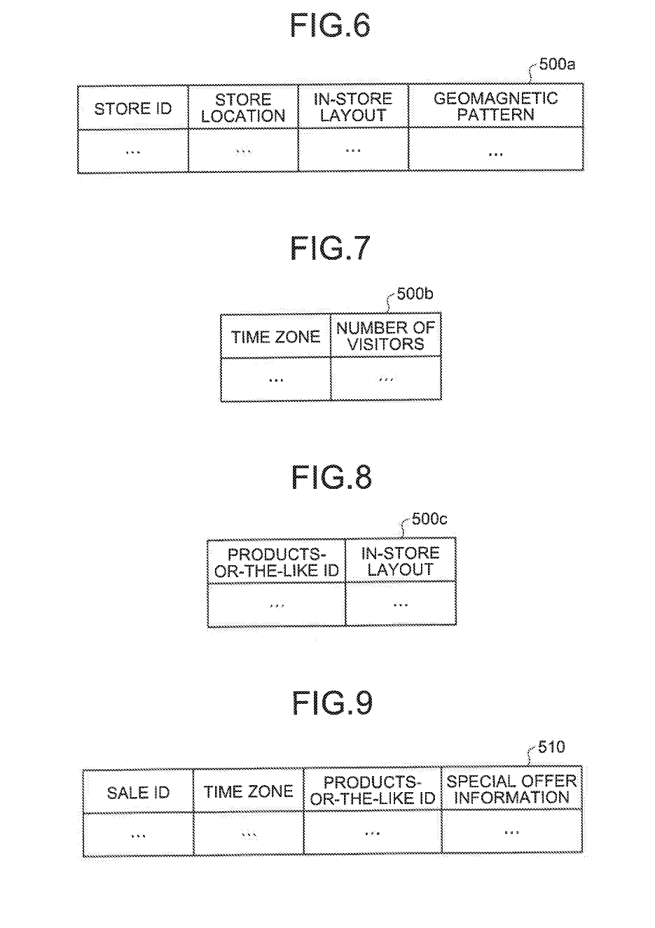

The database server 500 is implemented by, for example, a hard disc drive (HDD), a flash memory, an electrically erasable programmable read only memory (EEPROM), a read only memory (ROM), or a random access memory (RAM), or, alternatively, a hybrid storage device that uses these devices. The database server 500 may also be implemented by an external storage device accessible via various networks. An example of the external storage device includes a network attached storage (NAS) device. The database server 500 manages, for example, the databases illustrated in FIGS. 6 to 12.

FIG. 6 is a diagram illustrating an example of the store database 500a according to the embodiment. The store database 500a is information obtained by associating, for example, the store ID with information on a store location, information on an in-store layout, and a geomagnetic pattern. The store ID is information for uniquely specifying a store. The information on the store location is information indicating the location of the store by using latitude and longitude. The information on the in-store layout is information on arbitrary names in the store. The geomagnetic pattern is information indicating a variation in geomagnetism that can be acquired by the geomagnetic sensor 134 in the store.

FIG. 7 is a diagram illustrating an example of the number-of-visitors database 500b according to the embodiment. The number-of-visitors database 500b is information indicating a relationship between, for example, information on the time zone and information on the number of visitors in the store. The time zone indicates each of the time periods obtained by dividing business hours in the store. The information on the time zone is set based on the operation performed on the store terminal device 230. The number of visitors information is information indicating the number of users entered from the entrance of the store. The information on the number of visitors is information indicating, for example, the number of users based on an output of the sensor provided at the entrance of the store. The number-of-visitors database 500b may also indicate the number of daily visitors; however, the information is not limited to this. For example, the information may also be the average of the number of monthly visitors in each time zone.

FIG. 8 is a diagram illustrating an example of the product-or-the-like database 500c according to the embodiment. The product-or-the-like database 500c is information indicating a relationship between, for example, a product-or-the-like ID and information on the in-store layout in the store. The product-or-the-like ID is information for uniquely specifying products or the like. The information on the in-store layout is information on an arbitrary name in the store.

FIG. 9 is a diagram illustrating an example of the sale database 510 according to the embodiment. The sale database 510 is information obtained by associating, for example, the sale ID with the time zone, the product-or-the-like ID targeted for a sale, and special offer information. The sale ID is information for uniquely specifying a sale that is set by the store support server 300. The time zone is information indicating the start and end periods of a time sale. The product-or-the-like ID is information for uniquely specifying products or the like targeted for a sale specified by the sale ID. The special offer information is information indicating the content of the special offer that is granted on condition that products or the like are purchased in the sale specified by the sale ID. The details of the special offer are, a discount rate or a discount amount of each of the products or the like, a grant rate of a point that can be used for a settlement instead of cash, a ticket that can be used for a purchase of products or the like next time.

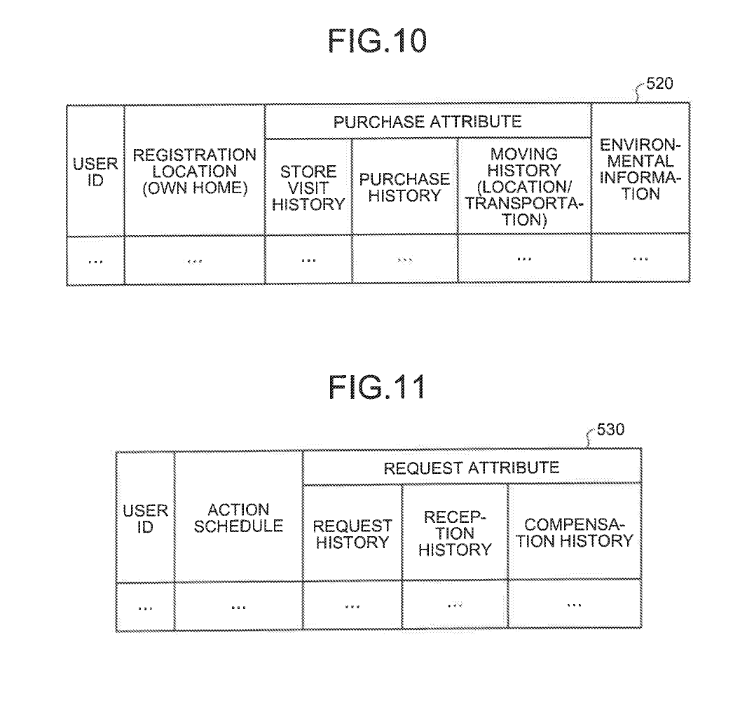

FIG. 10 is a diagram illustrating an example of the product-or-the-like purchase database 520 according to the embodiment. The product-or-the-like purchase database 520 is information obtained by associating, for example, the user ID with the registration location of the user's home, the purchase attribute, and environmental information. The purchase attribute is information including, for example, a store visit history, a purchase history, and a moving history. The store visit history is information including, for example, a visited store and the visited date and time. The information on the visited date and time may also include information indicating whether the visited date and time falls on the time sale set by the store support server 300. The purchase history is information including the products or the like purchased in the subject store. The information on the products or the like may also include information indicating whether the subject products or the like are the products or the like targeted for the time sale. The moving history is information including a moving path to the subject store or the type of transportation. The type of transportation is information indicating, for example, walking, a bicycle, a car, or the like. The environmental information is information on weather, an atmospheric temperature, or the like associated with the purchase attribute. The type of transportation is created based on, for example, the result of a discount process of a bicycle parking unit or a car parking space performed by the POS terminal 210 in the store.

FIG. 11 is a diagram illustrating an example of the agency-service request database 530 according to the embodiment. The agency-service request database 530 is information obtained by associating, for example, the user ID, with an action schedule and a request attribute. The action schedule is information including, for example, the date and time and the location in the future registered based on the operation performed by each of users. The request attribute is information including, for example, a request history, a reception history, and a compensation history. The request history is information including the date and time on which a shopping agency service is requested and including the products or the like requested via the shopping agency service. The reception history is information including the date and time on which the products or the like requested via shopping agency service were received from the agency-service representative. The compensation history is information including the date and time or the like of the compensation paid to the agency-service representative.

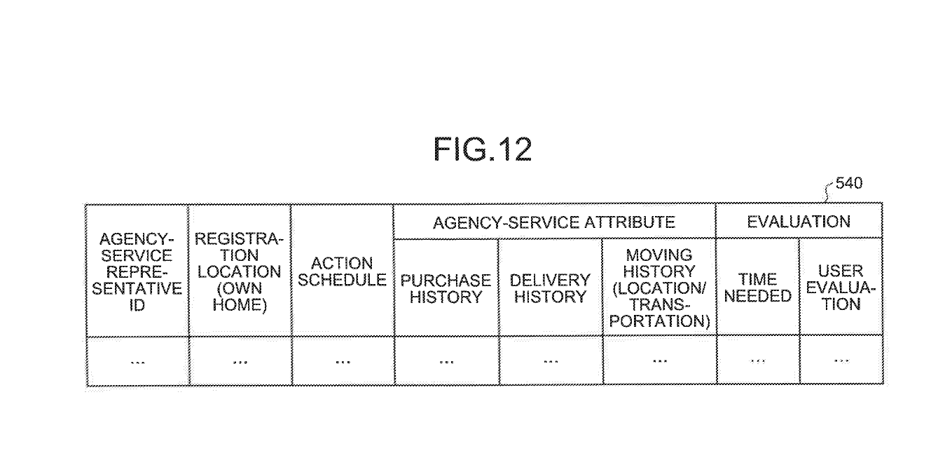

FIG. 12 is a diagram illustrating an example of the agency-service record database 540 according to the embodiment. The agency-service record database 540 is information obtained by associating, for example, the agency-service representative ID with the registration location of the own home, the action schedule, the agency-service attribute, and evaluation. The agency-service attribute is information including, for example, a purchase history, a delivery history, and a moving history. The purchase history is information including the date and time on which the agency-service representative purchased products or the like on behalf of a user and including the products or the like purchased by the agency-service representative. The delivery history is information including, for example, the date and time on which the products or the like were delivered from the agency-service representative to the requester. The moving history is information including the moving path of the agency-service representative and the type of transportation. The evaluation is information obtained by associating, for example, the time needed with a user evaluation. The time needed is information indicating the time period from the date and time on which the requester requested the shopping agency service to the date and time on which the agency-service representative delivered the products or the like. The user evaluation is information indicating the evaluation of the agency-service representative based on the operation received from the requester.

3. Sale Automatic Setting Process Performed in the Store Support System 1

3-1. Process Mainly Performed by the Store Support Server 300

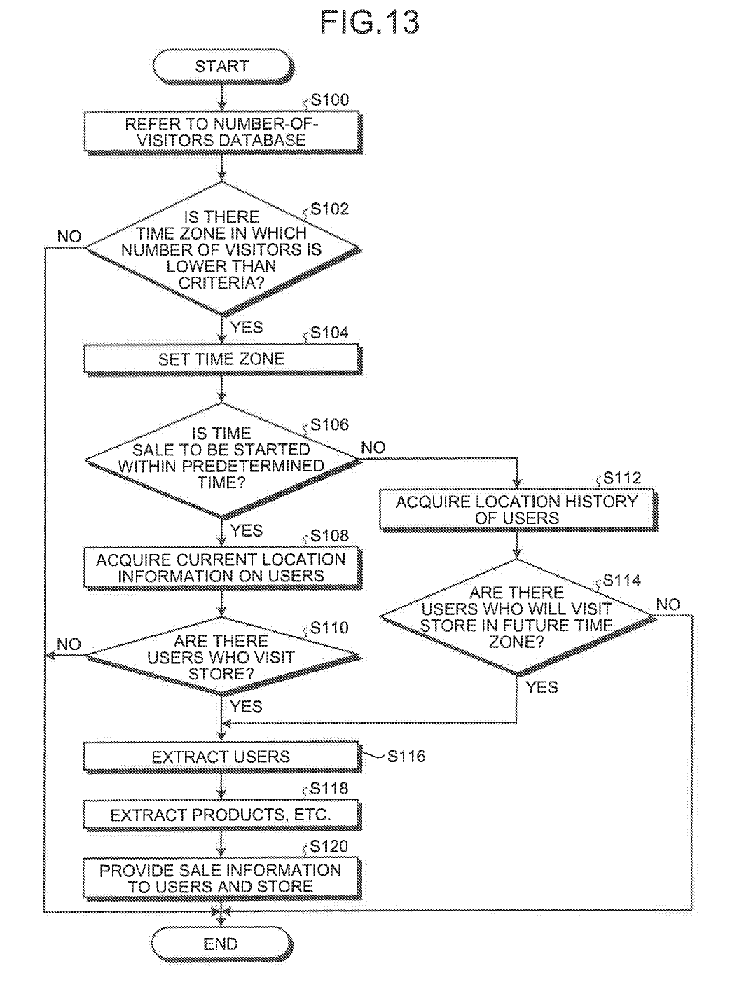

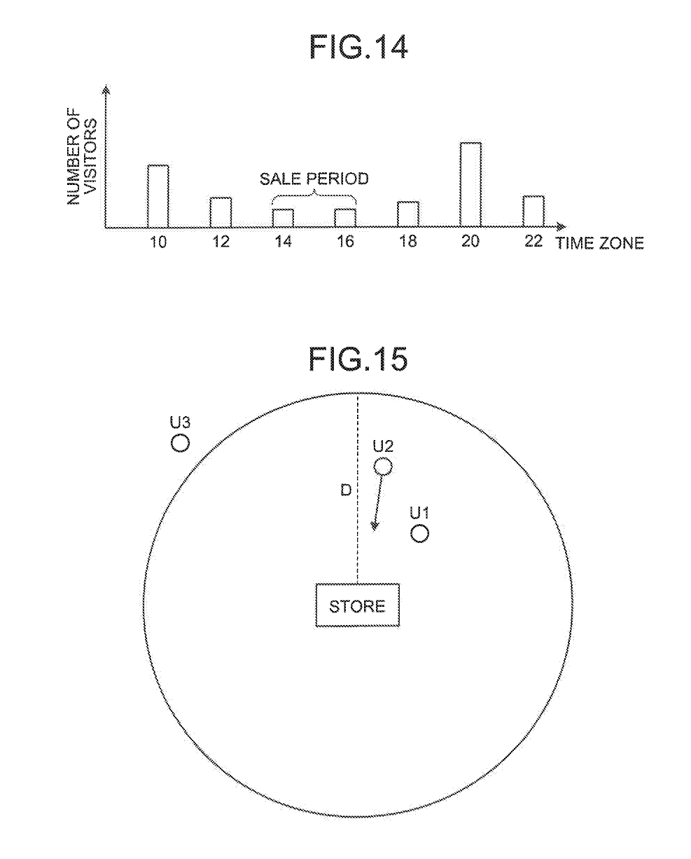

FIG. 13 is a flowchart illustrating the flow of the sale automatic setting process performed in the store support system 1 according to the embodiment. The process of the flowchart is started in, for example, for each predetermined time period. First, the time zone setting unit 310 in the store support server 300 refers to the number-of-visitors database 500b (Step S100). The time zone setting unit 310 determines whether there is a time zone (off-peak) in which the number of visitors is lower than the criteria (Step S102). If the time zone (off-peak) in which the number of visitors is lower than the criteria is not present, the time zone setting unit 310 ends the process of the flowchart. If the time zone (off-peak) in which the number of visitors is lower than the criteria is present, the time zone setting unit 310 sets the time zone in which the number of visitors is lower than the criteria as the sale period (Step S104). FIG. 14 is a diagram illustrating a process of setting a sale period performed by the store support server 300. In the example illustrated in FIG. 14, the time zone setting unit 310 sets, as the sale period, for example, the time zones between 14:00 to 16:00 and 16:00 to 18:00 that are the time zones lower than the average of the time zones or lower than an arbitrary determined reference value.

Then, the store support server 300 determines whether a time sale is to be started within a predetermined time (Step S106). If the time sale is started within a predetermined time, the store support server 300 acquires the current location information on users (Step S108). The store support server 300 determines, based on the acquired current location information, whether there are users who visit the time sale that is started within a predetermined time (Step S110).

If there are users who visit the time sale started within a predetermined time, the user extracting unit 320 extracts the users as the users who are likely to visit the time sale held in the store (Step S116). FIG. 15 is a diagram illustrating a process of extracting users. If the current location of each of the users is within a predetermined distance D from the store and/or if the moving direction of each of the users is the direction towards the store, the user extracting unit 320 extracts the subject users as the users who are likely to visit the store. For example, the user extracting unit 320 extracts the user U2 from users U1, U2, and U3.

If the time sale is not started within the predetermined time, the store support server 300 acquires the location history of the users (Step S112). At this time, the store support server 300 refers to the moving history in the product-or-the-like purchase database 520. The store support server 300 determines, based on the acquired location history, whether there are users who will visit the store in the future time zone (Step S114).

If there are users who will visit the time sale started within the predetermined time in the store, the user extracting unit 320 extracts the subject users as the users who are likely to visit the time sale held in the store (Step S116). If there is a history indicating that users are located around the store in the time zone of the time sale that is set by the time zone setting unit 310, [symbol] ated by the first user as the second user, wherein [symbol] ermediating unit requests the terminal device Furthermore,

Furthermore, at Step S116, the user extracting unit 320 may also narrows down users who are likely to visit the store based on the environmental information (weather or an atmospheric temperature) and the environmental information in the time zone of the time sale that are associated with the store visit history. For example, in the product-or-the-like purchase database 520, regarding the users who are likely to visit the store, in the case where the environmental information associated with the store visit history does not indicate “rain”, if a weather forecast in the time zone of the time sale is “rain”, the subject users are excluded from the already extracted users.

Then, the product-or-the-like extracting unit 330 extracts, based on the purchase attribute of each of the users extracted by the user extracting unit 320, the products or the like targeted for granting a special offer (Step S118). The product-or-the-like extracting unit 330 extracts, in the purchase history of each of the users, the products or the like recorded in the purchase history in the store in which the time sale is started as the products or the like targeted for granting a special offer.

Furthermore, at Step S118, the product-or-the-like extracting unit 330 may also narrow down the products or the like based on the environmental information (weather or an atmospheric temperature) and the environmental information in the time zone of the time sale that are associated with the purchase history. For example, in the product-or-the-like purchase database 520, regarding users who are likely to visit the store, in the case where a specific product or the like, such as an “umbrella”, is not present in the purchase history in which the environmental information is “sunny”, if a weather forecast in the time zone of the time sale is “sunny”, a specific product or the like, such as the “umbrella, is excluded from the already extracted products or the like.

Furthermore, at Step S118, the product-or-the-like extracting unit 330 may also narrow down the products or the like based on the moving history of each of the users. For example, in the product-or-the-like purchase database 520, regarding the users extracted by the time zone setting unit 310, it is assumed that the way of transportation of the users who visit the store is by walking or by bicycle. In this case, the product-or-the-like extracting unit 330 excludes beverages sold in case from the products or the like targeted for granting the special offer and then narrows down to beverages sold separately that can be easily carried.

Then, the information providing unit 340 sends the sale information to the user terminal device 100 and the store server 200 (Step S120). The sale information includes information indicating, for example, the store having a sale, the time zone of the time sale, the target products, a special offer, and the like.

As described above, the store support system 1 according to the embodiment can provide the sale information suitable for a future specific time zone by performing the sale automatic setting process. Consequently, the store support system 1 can improve an increase in the number of users who visit the store.

3-2. Process of Notifying Users of a Time Sale

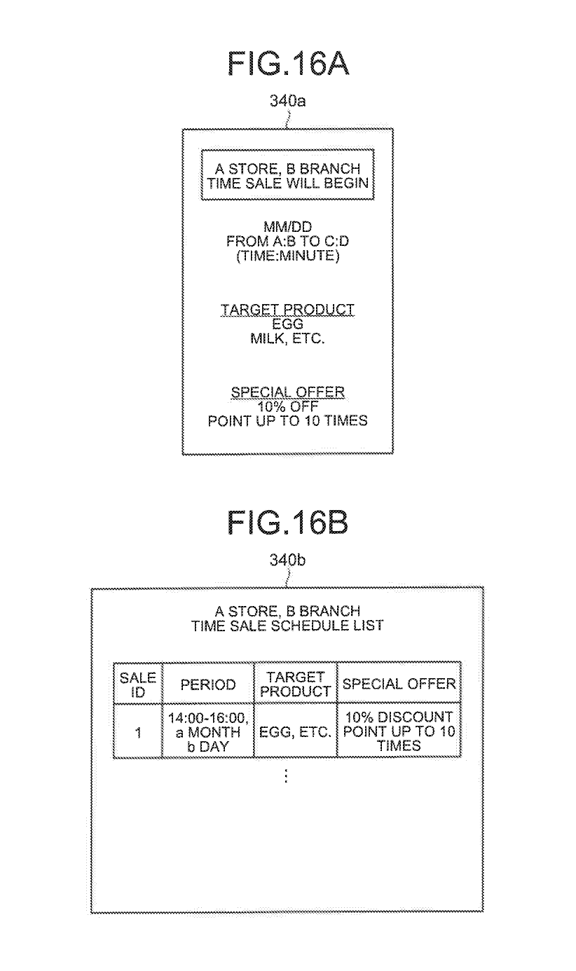

FIG. 16A is a diagram illustrating an example of the content 340a provided by the user terminal device 100. The information providing unit 340 notifies, as a push notification, the user terminal device 100 of, for example, the sale information that is the content 340a to be displayed on the user terminal device 100. Furthermore, the information providing unit 340 may also previously send the information for creating an image to the user terminal device 100 such that the content 340a can be browsed when the user terminal device 100 starts up a sale notification application.

3-3. Publicity of a Time Sale in a Store and Granting of a Special Offer

FIG. 16B is a diagram illustrating an example of the content 340b provided by the store terminal device 230. If the store server 200 receives the sale information, the store server 200 displays the content 340b on the store terminal device 230. The content 340b includes therein the sale ID, the time period, the target products or the like, and the special offer information. Consequently, the store support system 1 can make the content of the time sale that is automatically set in the store support server 300 known to all of the clerks. Furthermore, the store server 200 allows the POS terminal 210 and the point granting device 220 to start an operation of granting a special offer in the time period of the time sale on condition that the target products or the like are purchased.

3-4. Learning Process (1) of Extracting Users

The store support server 300 may provide, in the process at Step S120 in the flowchart illustrated in FIG. 13, the sale information to the user terminal devices 100 that are used by the users other than the users who are likely to visit the store. In this case, after having provided the sale information, the user attribute learning unit 322 refers to the product-or-the-like purchase database 520 and acquires the store visit history of the users other than the users who are likely to visit the store. Then, the user attribute learning unit 322 learns, based on the store visit history of the users other than users who are likely to visit the store, the time zone related to the time sale, the target products or the like, and the attributes of the users with respect to the special offer. The attributes of the users mentioned here are the indexes, such as sex, age, and a location history, that are used to classify the users. Specifically, if a certain user visits the store, the user attribute learning unit 322 increases the weighting of the attribute of the subject user. Consequently, the user attribute learning unit 322 can allow the user extracting unit 320 to easily extract the user who matches the attribute of the subject user.

3-5. Learning Process (2) of Extracting Users

The user attribute learning unit 322 may allow the user extracting unit 320 to easily extract, based on the purchase attributes of the users related to the products or the like, the users who purchased the products or the like other than the products or the like that are targeted for granting a special offer. The user attribute learning unit 322 refers to the store visit history and the purchase history held in the product-or-the-like purchase database 520 and extracts, from among the users who visited the time sale held in the past in the store, the users who purchased the products or the like other than the products or the like targeted for the time sale. The user attribute learning unit 322 sets, to the extracted users, the attribute indicating that the extracted users purchase the products or the like other than the products or the like targeted for the time sale. Consequently, the store support server 300 can actively provide the sale information to the users who tend to purchase a product (“buy as well”) different from the products targeted for the sale. Consequently, it is possible to promote the sales in the store.

3-6. Providing of Sale Information on Related Stores

The store support server 300 may provide, based on the store visit history of each of the users who use the user terminal devices 100 in each of which the sale information is provided, the sale information including the special offer granted on condition that the store related to the store that is visited by the subject users is used. Specifically, if a time sale of selling milk at a special price was held at 14:00, information indicating that the time sale of milk at a special price is going to be held from 14:00 at a later date in a store B that is accessible from the store A on foot is sent, as a recommendation, to the customer group who currently visit the store A on foot. Consequently, the store support server 300 can improve an increase in the number of visitors in the store B in addition to the store A.

4. Sale Automatic Start Process Performed in the Store Support System 1

In the following, a description will be given of a process of providing, in the store support system 1, the sale information to the user terminal devices 100 based on the purchase attributes of at least one of users who are currently visiting the store and users who are highly likely to visit the store.

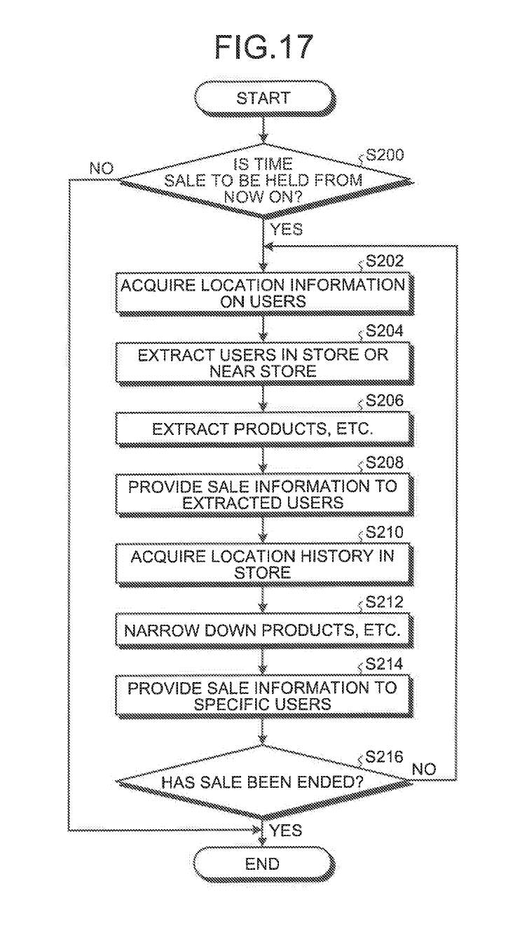

FIG. 17 is a flowchart illustrating the flow of the sale automatic start process performed in the store support system 1 according to the embodiment. First, the store support server 300 determines whether a time sale is to be held from now on (Step S200). The word of “from now on” mentioned here means, for example, “as soon as preparation has been completed”, “immediately without delay”, or “within a predetermined time (for example, about one hour)” If the time sale is not held from now on, the store support server 300 ends the process illustrated in the flowchart. If the time sale is held, the store support server 300 acquires the location information from the user terminal devices 100 (Step S202).

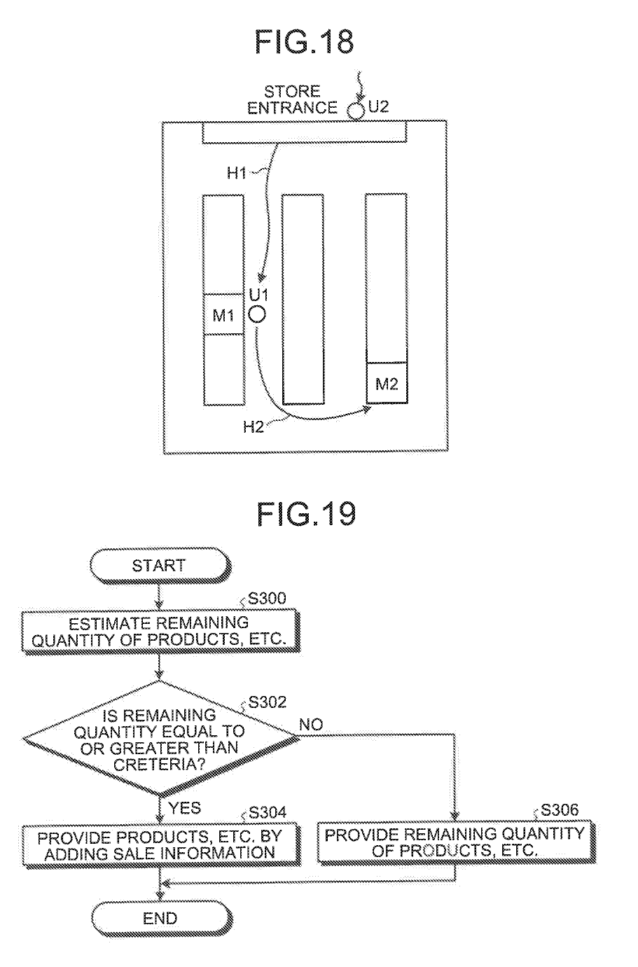

Specifically, the store support server 300 acquires the history of the location information acquired by the GPS processing unit 132 and the geomagnetic pattern detected by the geomagnetic sensor 134. FIG. 18 is a diagram illustrating a relationship between the location of a store and the location of a user. Based on a comparison between the geomagnetic pattern that is detected by the user terminal device 100 used by the user U1 and the geomagnetic pattern that is previously registered in the store database 500a, the store support server 300 acquires the location of a user U1 who is currently visiting the store. Furthermore, if the history of the location information acquired by the GPS processing unit 132 is cut out near the entrance of the store, the store support server 300 estimates that the user who is associated with the user terminal device 100 and who has sent the subject location information is present in the store. Consequently, the user extracting unit 320 extracts the user who is in the store or near the store (Step S204). For example, the user extracting unit 320 extracts users U1, and U2.

Then, the product-or-the-like extracting unit 330 extracts the products or the like targeted for granting the special offer (Step S206). The product-or-the-like extracting unit 330 extracts, for example, the products or the like based on the purchase attributes of the users extracted by the time zone setting unit 310. Furthermore, the product-or-the-like extracting unit 330 may extract the products with a lot of inventory in the store and their expiration date is coming soon as the products or the like targeted for granting the special offer. Then, the information providing unit 340 sends the sale information including the information, such as the extracted products or the like and the special offer, to the user terminal devices 100 and the store servers 200 (Step S208). Consequently, the store support server 300 automatically starts the time sale.

Then, the product-or-the-like extracting unit 330 acquires the location information on the users in the store (Step S210). For example, it is assumed that, as indicated by the moving history H1 illustrated in FIG. 18, the user U1 moves to a location M1 in which the products or the like targeted for the time sale are displayed and then moves to, as indicated by the moving history H2, another location M2. The product-or-the-like extracting unit 330 narrows down, based on the location history of the user, the products or the like targeted for granting the special offer from the products or the like displayed in the location M1 to the products or the like displayed in the location M2 (Step S212). At this time, the product-or-the-like extracting unit 330 refers to the product-or-the-like database 500c and acquires the information on the products or the like associated with the location in the store. Then, the information providing unit 340 provides the sale information including the information on the narrowed down products or the like to the user terminal device 100 used by a specific user (Step S214). Consequently, the store support server 300 can specify the route of the users who are present in a strolling path and provide the sale information targeted on the appealing products or the like to the users who are present in a strolling path.

Then, the store support server 300 determines whether the time sale has been ended (Step S216). If time sale has not been ended, the store support server 300 returns the process to Step S202. If the time sale has been ended, the store support server 300 ends the process illustrated in the flowchart.

As described above, the store support system 1 according to the embodiment can automatically set, based on the purchase attributes of at least one of users who are currently visit the store and users who are highly likely to visit the store, a time sale in which a special offer is added to the specific products or the like suitable for the purchase attributes of the users. Consequently, the store support system 1 can promote the purchase of the products or the like.

5. Providing the Remaining Quantity Information

5-1. Process of Providing the Remaining Quantity Information

FIG. 19 is a flowchart illustrating the flow of a process of providing remaining quantity information performed in the store support system 1 according to the embodiment. The store support system 1 according to the embodiment described above provides the remaining quantity information on the products or the like targeted for the time sale to the user terminal devices 100 in the middle of the time sale. First, a remaining quantity estimating unit 342 estimates the remaining quantity of the target products for the time sale (Step S300). The process of estimating the remaining quantity in detail will be described later. The information providing unit 340 determines whether the remaining quantity of the estimated products or the like is equal to or greater than the criteria (Step S302).

If the remaining quantity of the estimated products or the like is equal to or greater than the criteria, the information providing unit 340 provides the products or the like by adding the sale information (Step S304). The information providing unit 340 again provides, for example, the sale information. Furthermore, the information providing unit 340 provides new sale information including the special offer information in which a discount amount or a point grant rate is changed to high. Consequently, the information providing unit 340 notifies the users of the time sale.

If the remaining quantity of the products or the like is not equal to or greater than the criteria, the information providing unit 340 provides the sale information including the remaining quantity information on the products or the like (Step S306). The information providing unit 340 provides the sale information including information indicating that, for example, the target product of the time sale will be sold out soon.

5-2. Process of Estimating the Remaining Quantity (1)

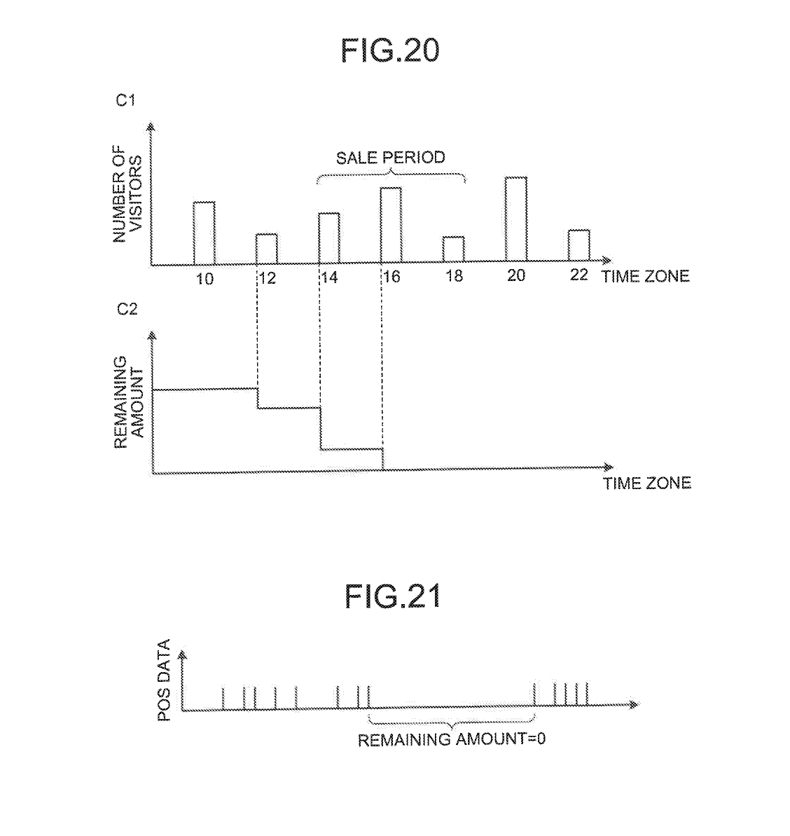

FIG. 20 is a diagram illustrating an example of a process of estimating a remaining quantity of products or the like. The remaining quantity estimating unit 342 refers to, as illustrated in C1 in FIG. 20, the product-or-the-like purchase database 520 and acquires the store visit history associated with the user terminal device 100 that has provided the sale information. The remaining quantity estimating unit 342 estimates the remaining amount of the products or the like based on the acquired store visit history. As illustrated in C2 in FIG. 20, the remaining quantity estimating unit 342 estimates that, from among the users who have the user terminal devices 100 in each of which the sale information has been provided, the remaining quantity of the products is smaller as the number of visited users is larger.

5-3. Process of Estimating the Remaining Quantity (2)

FIG. 21 is a diagram illustrating an example of another process of estimating the remaining quantity of the products or the like. The remaining quantity estimating unit 342 may also estimate the remaining amount of the products or the like in the store based on the real time data that is related to the sales record in the store and that has been provided from the POS system including the POS terminal 210. The real time data is generated every time a product or the like targeted for the time sale is sold, whereas the real time data is paused when the remaining quantity of the products or the like targeted for the time sale becomes zero. The remaining quantity estimating unit 342 estimates the remaining quantity of the product targeted for the time sale based on the pattern of the real time data. Furthermore, the remaining quantity estimating unit 342 may also perform both processes of estimating the remaining quantities and may also provide the sale information based on the two estimated remaining quantities of the products.

6. Inventory Inquiry Process and Agency-Service Request Process

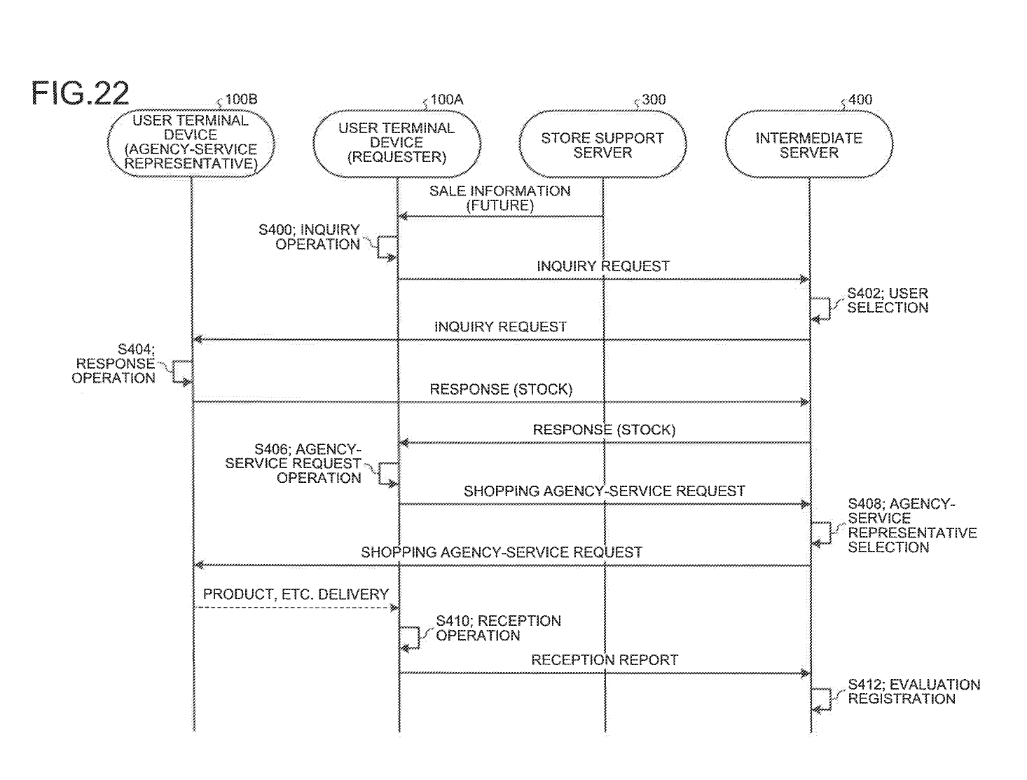

FIG. 22 is a flowchart illustrating the flow of a stock inquiry process and an agency-service request process. In this description, the user terminal device 100 used by a requester of the shopping agency service is also referred to as a requester terminal device 100A and the user terminal device 100 used by an agency-service representative of the shopping agency service is also referred to as an agency-service representative terminal device 100B.

6-1. Inventory Inquiry Process

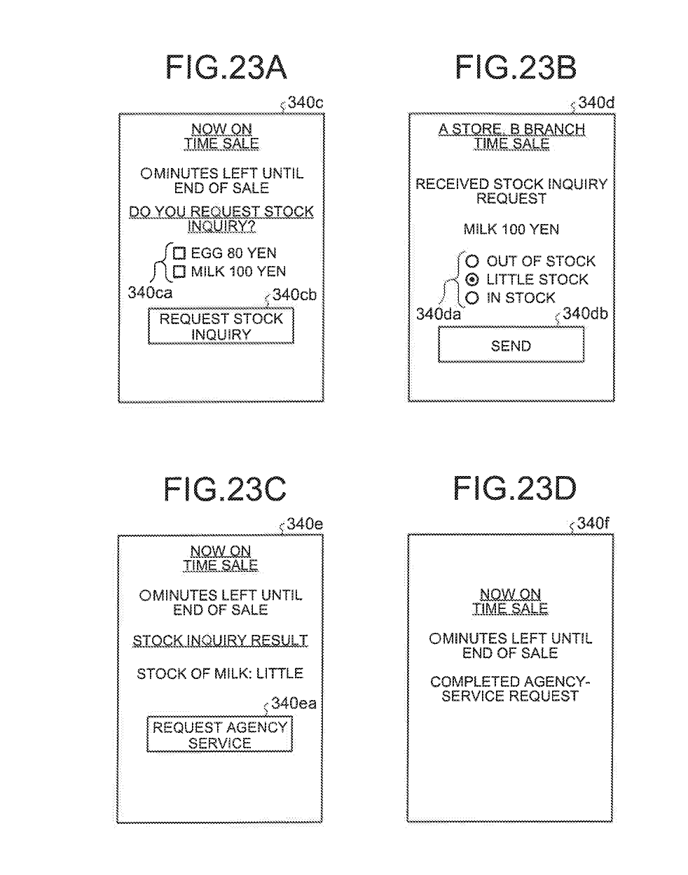

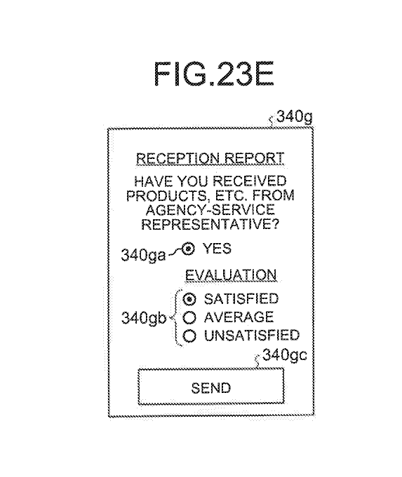

The store support server 300 sends the sale information related to the time sale held in the future time zone to the requester terminal device 100A. If the requester terminal device 100A receives the sale information, the requester terminal device 100A provides the content 340a by using the sale notification processing unit 110. Furthermore, if the intermediate processing unit 120 in the requester terminal device 100A receives a predetermined operation from a requester in the middle of the time sale, the intermediate processing unit 120 provides the content 340c that is used to inquire the stock of the target product of the time sale (Step S400). FIG. 23A is a diagram illustrating an example of the content 340c. In the content 340c, the time to the end of the time sale, a check box 340ca used to select the target product of the time sale, and a stock inquiry button 340cb are included. If the target product is designated and if an operation of selecting the stock inquiry button 340cb is received, the intermediate processing unit 120 sends a request for an inquiry of the stock of the designated target product to the intermediate server 400.

If the intermediate server 400 receives an inquiry request for a product or the like, the intermediate server 400 selects the user terminal device 100 that is used by the user who is present in the store (Step S402), and provides the inquiry request for the product or the like to the selected user terminal device 100 (the agency-service representative terminal device 100B). If the intermediate processing unit 120 in the agency-service representative terminal device 100B receives the inquiry request from the intermediate server 400, as illustrated in FIG. 23B, the intermediate processing unit 120 provides content 340d that is used to reply to the stock inquiry. In the content 340d, the product or the like targeted for the stock inquiry, radio buttons 340da used to select the content of a reply, and a send button 340db are included. If the intermediate processing unit 120 in the agency-service representative terminal device 100B receives an operation selected by the send button in a state in which one of the radio buttons is being selected, the intermediate processing unit 120 sends a response to the intermediate server 400 (Step S404).

If the intermediate server 400 receives a response from the agency-service representative terminal device 100B, the intermediate server 400 sends the information indicating the stock of the target product or the like to the requester terminal device 100A as a response to the inquiry request. Consequently, the intermediate server 400 provides the stock of the product or the like to the requester.

6-2. Agency-Service Request Process

If the requester terminal device 100A receives the response, as illustrated in FIG. 23C, the requester terminal device 100A provides the content 340e. In the content 340e, the time to the end of the time sale, the result of the stock inquiry, and an agency-service request button 340ea are included. If the intermediate processing unit 120 in the requester terminal device 100A receives an operation of selecting an agency-service request button 340ea, the intermediate processing unit 120 sends a shopping agency-service request to the intermediate server 400 (Step S406). If the requester terminal device 100A sends the shopping agency-service request, as illustrated in FIG. 23D, the requester terminal device 100A provides the content 340f used to exhibit a request for the shopping agency service.

If the intermediate server 400 receives the shopping agency-service request, the intermediate server 400 selects an agency-service representative of the shopping agency service (Step S408). The intermediate server 400 sends the shopping agency-service request to the agency-service representative terminal device 100B that is used by the selected agency-service representative. The agency-service representative who has received the request for the shopping agency service purchases the target product based on the shopping agency-service request and delivers the target product to the requester. The intermediate processing unit 120 in the requester terminal device 100A reports the reception of the product or the like requested from the shopping agency service (Step S410). At this time, as illustrated in FIG. 23E, the intermediate processing unit 120 provides the content 340g. In the content 340g, a radio button 340ga used to reply indicating that the product or the like has been received from the agency-service representative, radio buttons 340gb used to receive an evaluation of the shopping agency service, and the send button 340gc are included. If the send button 340gc is selected in the state in which both the radio button 340ga that is used to send the reception as a reply and the radio button 340gb that is used receive the evaluation are being selected, the intermediate processing unit 120 sends reception report information to the intermediate server 400.

If the intermediate server 400 receives the reception report information, the intermediate server 400 registers the time needed and a user evaluation of the agency-service representative included in the agency-service record database 540 (Step S412). Furthermore, the intermediate server 400 stores, in the compensation history included in the agency-service request database 530, information indicating that the requester pays compensation to the agency-service representative.

In the stock inquiry process and the agency-service request process described above, the shopping agency-service request is sent to the agency-service representative terminal device 100B that has sent the response to the inquiry request; however, the embodiment is not limited to this. The intermediate server 400 may send, in the case where a response to the inquiry request is not received, the information indicating this state to the requester terminal device 100A and select, in the case where a shopping agency-service request is received from the requester terminal device 100A, the agency-service representative as described later and send the shopping agency-service request to the selected agency-service representative. Furthermore, even if the intermediate server 400 has not received an inquiry request from the requester terminal device 100A, the intermediate server 400 may select, in the case where the shopping agency-service request is received from the user terminal device 100, the agency-service representative as described above and send the shopping agency-service request to the selected agency-service representative.

6-3. Detail of the Agency-Service Request Process

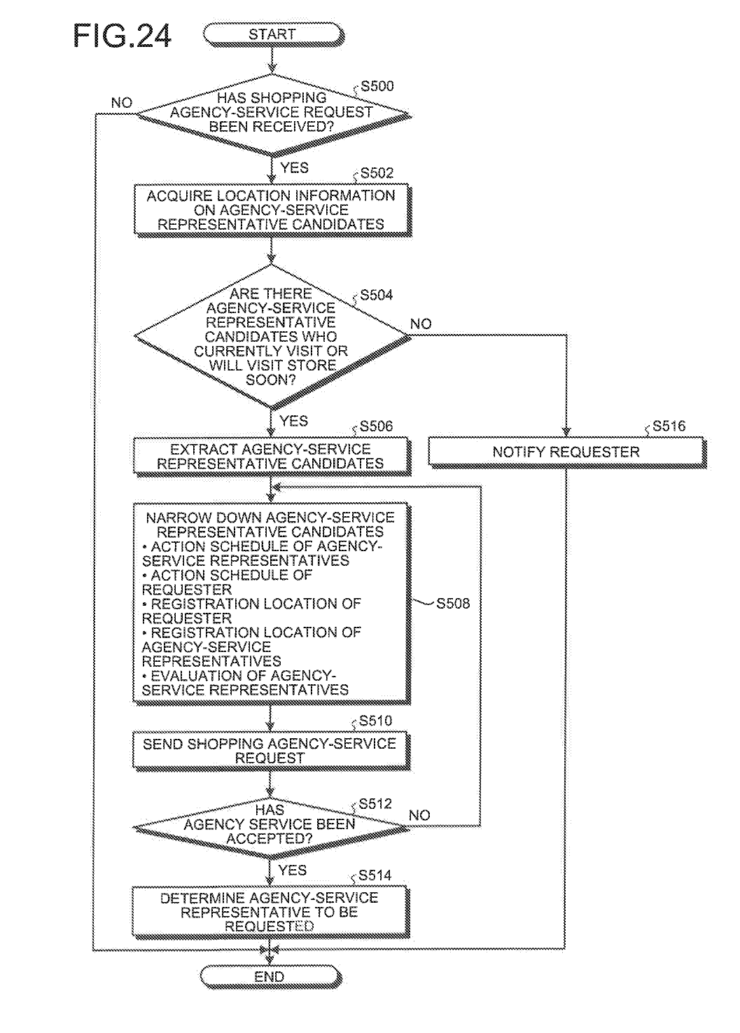

FIG. 24 is a flowchart illustrating an example of the flow of the agency-service request process.

The agency-service processing unit 420 determines whether a shopping agency-service request has been received from the requester terminal device 100A (Step S500). If the agency-service processing unit 420 has not been received the shopping agency-service request, the agency-service processing unit 420 ends the process illustrated in the flowchart. If the agency-service processing unit 420 has received the shopping agency-service request, the agency-service processing unit 420 acquires the location information on agency-service representative candidates (Step S502). The agency-service processing unit 420 acquires the location information on each of the agency-service representative candidates by acquiring the location information on the agency-service representative terminal devices 100B associated with, for example, the agency-service representatives ID registered in the agency-service record database 540. Furthermore, if the agency-service representative candidate designated as a requester is present, the agency-service processing unit 420 may acquire the location information on the designated agency-service representative candidate. Furthermore, the agency-service processing unit 420 may also extract, as an agency-service representative candidate, a user registered in the agency-service request database 530 even if the user is not registered as an agency-service representative.

Then, the agency-service processing unit 420 determines whether there are agency-service representative candidates who are currently visiting the store that sells the product or the like designated by the shopping agency-service request or agency-service representative candidates who are highly likely to visit the subject store (Step S504). If the agency-service representative candidates are not present, the agency-service processing unit 420 notifies the requester of this state (Step S516).

If the agency-service representative candidates are present, the agency-service processing unit 420 extracts the existing agency-service representative candidates (Step S506). Then, the agency-service processing unit 420 narrows down the agency-service representative candidates (Step S508). The agency-service representative designating unit 422 refers to the agency-service record database 540 and narrows down, based on the action schedule of each of the users, the agency-service representative candidates as the agency-service representatives who are the users who are highly likely to visit the store that sells the products or the like designated by the shopping agency-service request. The action schedule of each of the users is information received by the intermediate server 400 in the agency-service representative terminal device 100B. Specifically, an example of the action schedule of each of the users includes areas in which agency-service representatives go shopping, stores, the type of stores, and the like.

The agency-service representative designating unit 422 may narrow down the agency-service representative candidates based on a relationship between the registration locations, such as homes related to agency-service representatives, and the registration location, such as home related to a requester. Specifically, if the home location of the requester registered in the product-or-the-like purchase database 520 and the home location of an agency-service representative candidate registered in the agency-service record database 540 are within a predetermined distance, the agency-service representative designating unit 422 selects the subject agency-service representative candidate.

The agency-service representative designating unit 422 may narrow down the agency-service representative candidates based on a relationship between the action schedule of each of the agency-service representatives and the action schedule of a requester. Specifically, if the location point included in the action schedule of the requester and the location point included in the action schedule of an agency-service representative candidate are within a predetermined distance, the agency-service representative designating unit 422 selects the subject agency-service representative candidate.

The agency-service representative designating unit 422 may narrow down the agency-service representative candidates based on the evaluation of the agency-service representative candidates. Specifically, the agency-service representative designating unit 422 narrows down, from among a plurality of agency-service representative candidates, to a predetermined number of agency-service representative candidates whose delivery time needed is shorter. Furthermore, the agency-service representative designating unit 422 narrows down, from among the plurality of agency-service representative candidates, to a predetermined number of agency-service representative candidates who are not judged to be unsatisfactory by the user evaluation.

The agency-service requesting unit 423 sends a shopping agency-service request to the agency-service representative candidate (Step S510). Then, the agency-service requesting unit 423 determines whether a response to the shopping agency-service request indicating an acceptance of the shopping agency service has been received (Step S512). If the agency-service processing unit 420 is not able to receive the response indicating the acceptance of the shopping agency service, the agency-service processing unit 420 returns the process to Step S508. If the agency-service processing unit 420 has received the response indicating the acceptance of the shopping agency service, the agency-service processing unit 420 determines the accepted agency-service representative candidate as the agency-service representative to whom the shopping agency service is requested (Step S514) and ends the process illustrated in the flowchart.

The store support system 1 described above extracts, as an agency-service representative, at least one of users who are currently visiting the store and users who are highly likely to visit the store; therefore, an advantage is provided in that it is possible to reduce the burden placed on the agency-service representative to move to the store in order to provide a shopping agency service.

7. Modification

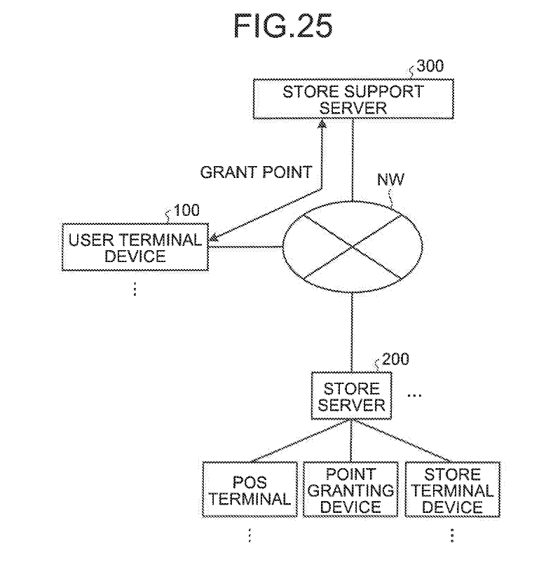

FIG. 25 is a diagram illustrating the configuration of the store support system 1 according to a modification.

The store support system 1 according to the embodiment described above performs the process of granting a special offer by the store server 200 by providing the sale information from the store support server 300 to the store server 200; however, the embodiment is not limited to this. The process of granting a special offer may also be performed in the store support server 300. Specifically, it is assumed that a user has purchased a target product of the time sale by using an electronic money function of the user terminal device 100. In this case, the user terminal device 100 sends the user ID, store information, product information, and purchase date and time information to the store support server 300. The store support server 300 determines, based on the information received from the store server 200, whether a special offer is granted and then grants the special offer if the user ID, the store information, the product information, and the purchase date and time information satisfy the condition for granting the special offer.

8. Hardware Configuration

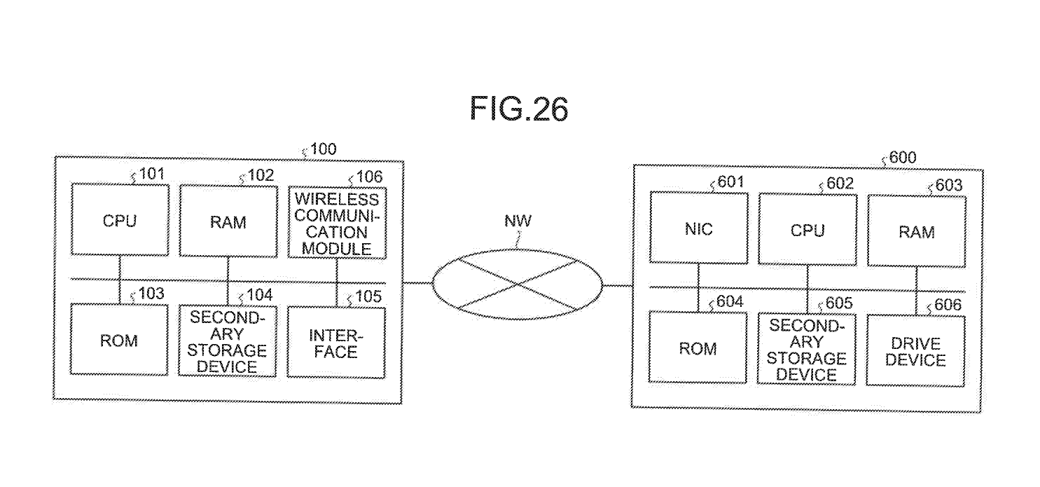

FIG. 26 is a diagram illustrating an example of hardware configuration of the user terminal device 100, the store server 200, the store support server 300, the intermediate server 400, and the database server 500. FIG. 26 illustrates an example in which the user terminal device 100 is a smart device, such as a smart phone, a tablet terminal, or the like. The user terminal device 100 has a configuration in which, for example, a CPU 101, a RAM 102, a ROM 103, a secondary storage device 104, such as a flash memory, an interface 105 (e.g. a touch panel), and a wireless communication module 106 are connected with each other by an internal bus or a private communication line. Application programs or the like that operates the user terminal device 100 are stored in the secondary storage device 104.

A server 600 is an example of the store server 200, the store support server 300, the intermediate server 400, or the database server 500. The server 600 has the configuration in which, for example, a network interface card (NIC) 601, a CPU 602, a RAM 603, a ROM 604, a secondary storage device 605, such as a flash memory or an HDD, and a drive device 606 are connected with each other by an internal bus or a private communication line. A portable storage medium, such as an optical disk, is mounted on the drive device 606. The programs stored in the portable storage medium mounted on the secondary storage device 605 or the drive device 606 are loaded in the RAM 603 by a DMA controller (not illustrated), or the like and executed by the CPU 602, whereby the functioning units in each of the servers are implemented.

The present invention is not limited to the embodiments and modifications and replacements may be made within the scope of the invention.

According to one aspect of the embodiments, it is possible to reduce the burden placed on a shopping agency-service representative.

The embodiments described above can be described as follows.

(1-1)

A store support system comprising:

a time zone setting unit that sets a time zone;

a user extracting unit that extracts users who are likely to visit a store in the time zone that is set by the time zone setting unit; and

a providing unit that provides, to a terminal device that is used by each of the users extracted by the user extracting unit, sale information including a special offer that is granted on condition that the store is used.

(1-2)

The store support system according to description (1-1), wherein the time zone setting unit extracts, as the time zone from the available time of the store, based on a visitor history of the store, a time zone in which the number of visitors is lower than the criteria.

(1-3)

The store support system according to description (1-1), wherein the time zone setting unit extracts the time zone based on an operation received by a terminal device that is used by an administrator in the store.

(1-4)

The store support system according to any one of descriptions (1-1) to (1-3), wherein, when the current location of each of the users is within a predetermined distance from the store and/or when the moving direction of each of the users is the direction towards the store, the user extracting unit extracts the users as users who are likely to visit the store.

(1-5)

The store support system according to any one of descriptions (1-1) to (1-4), wherein, when there is a history indicating that the users were located around the store in the time zone set by the time zone setting unit, the user extracting unit extracts the users as the users who are likely to visit the store.

(1-6)

The store support system according to description (1-4) or (1-5), wherein, when there is a store visit history or a purchase history of each of the users in the store, the user extracting unit extracts the users as the users who are likely to visit the store.

(1-7)

The store support system according to description (1-4) or (1-5), wherein the user extracting unit extracts, based on environmental information associated with a history indicating that each of the users visited the store and based on environmental information in the time zone that is set by the time zone setting unit, the users who are likely to visit the store.

(1-8)

The store support system according to any one of descriptions (1-1) to (1-7), wherein

the providing unit provides the sale information to a terminal device that is used by a user other than the users who are likely to visit the store, and

the user extracting unit learns, based on the store visit history of the user other than the users who are likely to visit the store, an attribute of each of the users who are likely to visit the store and narrows down, based on the learning result, the users who are likely to visit the store.

(1-9)

The store support system according to any one of descriptions (1-1) to (1-7), further comprising a product-or-the-like extracting unit that extracts, based on a store visit attribute, the purchase history, or a moving history of each of the users extracted by the user extracting unit, the product or the like targeted for granting the special offer.

(1-10)

The store support system according to description (1-9), wherein the product-or-the-like extracting unit narrows down, based on the environmental information in the time zone set by the time zone setting unit, the products or the like targeted for granting the special offer.

(1-11)

The store support system according to description (1-9) or (1-10), wherein the product-or-the-like extracting unit narrows down, based on the moving history of each of the users, the products or the like targeted for granting the special offer.

(1-12)

The store support system according to any one of descriptions (1-1) to (1-11), further comprising a first estimating unit that estimates, after first sale information is provided by the providing unit, a remaining amount of the products or the like in the store based on the number of visitors in the time zone set by the time zone setting unit, wherein

the providing unit provides second sale information based on the remaining amount estimated by the first estimating unit.

(1-13)

The store support system according to any one of descriptions (1-1) to (1-11), further comprising a second estimating unit that estimates, after the first sale information is provided by the providing unit, the remaining amount of the products or the like in the store based on real time data on a sales record in the store provided from a system of a point of sale (POS) system, wherein

the providing unit provides second sale information based on the remaining amount estimated by the second estimating unit.

(1-14)

The store support system according to any one of descriptions (1-1) to (1-13), further comprising a first intermediating unit that provides, when an inquiry request for product or the like in the store is received from a first terminal device in which the sale information has been provided by the providing unit, an inquiry request for product or the like to a second terminal device that is used by at least one of the users who are currently visiting the store and the users who are highly likely to visit the store and that provides, in accordance with reception of a response including information related to the remaining amount of the products or the like from the second terminal device, the response to the first terminal device.

(1-15)

The store support system according to any one of descriptions (1-1) to (1-13), further comprising a second intermediating unit that requests, when a purchase request for the product or the like is received from the terminal device in which the sale information has been provided by the providing unit, a third terminal device that is used by at least one of the users who are currently visiting the store and the users who are highly likely to visit the store to purchase the product or the like.

(1-16)

The store support system according to description (1-15), wherein the second intermediating unit requests, with priority from among a plurality of the third terminal devices, the third terminal device that is used by a user located closer to the location designated by a user who uses the terminal device in which the sale information has been provided by the providing unit to purchase the product or the like.

(1-17)

The store support system according to any one of descriptions (1-1) to (1-16), wherein the providing unit provides, with priority, based on a purchase attribute of the product or the like of the users, the sale information to a fourth terminal device that is used by each of users who have purchased a product or the like other than the product or the like targeted for granting the special offer.

(1-18)

The store support system according to any one of descriptions (1-1) to (1-17), wherein the providing unit provides, based on the store visit history of the users who use the terminal devices in each of which the sale information has been provided by the providing unit, sale information including the special offer that is granted on condition that a store related to the store visited by the users is used.

(1-19)

The store support system according to any one of descriptions (1-1) to (1-18), the providing unit sends the sale information, as a push notification, to the terminal devices that are used by the corresponding users extracted by the user extracting unit.

(1-20)

The store support system according to any one of descriptions (1-1) to (1-19), wherein

the providing unit provides the sale information to a store server that is managed in the store, and

the store server starts, based on the sale information provided by the providing unit, an operation of granting a special offer on condition that the store is used.

(1-21)

A store support method comprising:

setting a time zone;

extracting users who are likely to visit a store in the set time zone; and

providing, to a terminal device used by each of the extracted users, sale information including a special offer that is granted on condition that the store is used.

(1-22)

A non-transitory computer readable storage medium having stored therein a store support program that causes a computer to execute a process comprising:

setting a time zone;

extracting users who are likely to visit a store in the set time zone; and

providing, to a terminal device used by each of the extracted users, sale information including a special offer that is granted on condition that the store is used.

(2-1)

A store support system comprising:

a user extracting unit that extracts at least one of users who are currently visiting a store and users who are highly likely to visit the store;

an attribute acquiring unit that acquires a purchase attribute of each of the users extracted by the user extracting unit; and

a providing unit that provides, based on the purchase attributes acquired by the attribute acquiring unit, to a terminal device used by the user, sale information including a special offer that is granted on condition that the store is used.

(2-2)

The store support system according to description (2-1), wherein the user extracting unit acquires the location of each of the users who are currently visiting the store based on a relationship between a signal pattern detected by a geomagnetism detecting unit mounted on the terminal device used by each of the users and a previously registered signal pattern and extracts, based on the acquired location of each of the users, the users who are currently visiting the store.

(2-3)

The store support system according to description (2-1) or (2-2), wherein, when the current location of each of the users is within a predetermined distance from the store and when the moving direction of each of the users is the direction towards the store, the user extracting unit extracts the users as users who are highly likely to visit the store.

(2-4)

The store support system according to any one of descriptions (2-1) to (2-3), wherein, when there is a store visit history or a purchase history of each of the users in the store, the user extracting unit extracts the users as the users who are highly likely to visit the store.

(2-5)

The store support system according to any one of descriptions (2-1) to (2-3), wherein the user extracting unit narrows down, based on environmental information associated with a history indicating that each of the users visited the store and based on environmental information in the time zone that is set by the time zone setting unit, the users who are highly likely to visit the store.

(2-6)

The store support system according to any one of descriptions (2-1) to (2-4), wherein

the providing unit provides the sale information to a terminal device used by a user other than the users who are likely to visit the store, and

the user extracting unit learns, based on the store visit history of the user other than the users who are likely to visit the store, an attribute of each of the users who are highly likely to visit the store and narrows down, based on the result of learning, the users who are highly likely to visit the store.

(2-7)

The store support system according to any one of descriptions (2-1) to (2-5), further comprising a product-or-the-like extracting unit that extracts, based on a store visit attribute, the purchase history, or a moving history of each of the users acquired by the attribute acquiring unit, the product or the like targeted for granting the special offer.

(2-8)

The store support system according to description (2-6), wherein

the user extracting unit acquires the location of each of the users who are currently visiting the store based on a relationship between a signal pattern detected by a geomagnetism detecting unit mounted on the terminal device used by each of the users and a previously registered signal pattern and extracts, based on the acquired location of each of the users, the users who are currently visiting the store, and

the product-or-the-like extracting unit narrows down, based on the history of the location of each of the users extracted by the user extracting unit, the product or the like targeted for granting the special offer.

(2-9)

The store support system according to description (2-6), wherein the product-or-the-like extracting unit narrows down, based on the current environmental information, the products or the like targeted for granting the special offer.

(2-10)

The store support system according to description (2-6) or (2-7), wherein the product-or-the-like extracting unit narrows down, based on the moving history of each of the users, the products or the like targeted for granting the special offer.

(2-11)

The store support system according to any one of descriptions (2-1) to (2-9), further comprising a first estimating unit that estimates, based on the number of visitors obtained after first sale information is provided by the providing unit, a remaining amount of the products or the like in the store, wherein

the providing unit provides second sale information based on the remaining amount estimated by the first estimating unit.

(2-12)

The store support system according to any one of description (2-1) to (2-10), further comprising a second estimating unit that estimates the remaining amount of the products or the like in the store based on real time data on a sales record in the store provided from a point of sale (POS) system, wherein

the providing unit provides, the remaining amount estimated by the second estimating unit, the sale information.

(2-13)

The store support system according to any one of descriptions (2-1) to (2-11), further comprising a first intermediating unit that provides, when an inquiry request for product or the like in the store is received from a first terminal device in which the sale information has been provided by the providing unit, an inquiry request for product or the like in the store to a second terminal device that is used by the user who is present in the store and that provides, in accordance with reception of a response including information related to the remaining amount of the products or the like from the second terminal device, the response to the first terminal device.

(2-14)

The store support system according to any one of descriptions (2-1) to (2-12), further comprising a second intermediating unit that requests, when a purchase request for the product or the like is received from the terminal device in which the sale information has been provided by the providing unit, a third terminal device that is used by the user who is likely to visit the store to purchase the product or the like.

(2-15)

The store support system according to description (2-13), wherein the second intermediating unit requests, with priority from among a plurality of the third terminal devices, the third terminal device that is used by a user located closer to the location designated by a user who uses the terminal device in which the sale information has been provided by the providing unit to purchase the product or the like.

(2-16)

The store support system according to any one of descriptions (2-1) to (2-14), wherein the providing unit provides, with priority, based on the purchase attribute of the product or the like of the users, the sale information to a fourth terminal device that is used by users who have purchased a product or the like other than the product or the like targeted for granting the special offer.

(2-17)

The store support system according to any one of descriptions (2-1) to (2-15), wherein the providing unit provides, based on the store visit history of the users who use the terminal device in each of which the sale information has been provided by the providing unit, sale information including the special offer that is granted on condition that a store related to the store visited by the users is used.

(2-18)

The store support system according to any one of descriptions (2-1) to (2-17), wherein the providing unit sends the sale information as a push notification.

(2-19)

The store support system according to any one of descriptions (2-1) to (2-17), wherein

the providing unit provides the sale information to a store server that is managed in the store, and

the store server starts, based on the sale information provided by the providing unit, an operation of granting a special offer on condition that the store is used.

(2-20)

A store support method comprising:

extracting at least one of users who are currently visiting a store and users who are highly likely to visit the store;

acquiring a purchase attribute of each of the extracted users; and

providing, based on the acquired purchase attribute, to a terminal device used by each of the users, sale information including a special offer that is granted on condition that the store is used.

(2-21)

A non-transitory computer readable storage medium having stored therein a store support program that causes a computer to execute a process comprising:

extracting at least one of users who are currently visiting a store and users who are highly likely to visit the store;

acquiring a purchase attribute of each of the extracted users; and

providing, based on the acquired purchase attribute, to a terminal device used by each of the users, sale information including a special offer that is granted on condition that the store is used.

(3-1)

An intermediate support system comprising:

a receiving unit that receives, from a first user, a purchase request for a product or a service sold in a store (hereinafter, referred to as the product or the like);

a user extracting unit that extracts a second user who is at least one of a user who are currently visiting the store and a user who is highly likely to visit the store; and

an intermediating unit that sends, based on the purchase request received by the receiving unit, to a terminal device used by the second user extracted by the user extracting unit, information that requests to purchase the product or the like.

(3-2)

The intermediate support system according to description (3-1), wherein the user extracting unit acquires a location of the user who is currently visiting the store based on a relationship between a signal pattern detected by a geomagnetism detecting unit mounted on the terminal device used by the user and a previously registered signal pattern and extracts, based on the acquired location of the user, the user who is currently visiting the store.

(3-3)

The intermediate support system according to description (3-1) or (3-2), wherein the user extracting unit extracts, based on action schedule of the user, the second user who is the user who are highly likely to visit the store.

(3-4)

The intermediate support system according to any one of descriptions (3-1) to (3-3), wherein the intermediating unit selects, from among the second users based on a relationship between a registration location related to the first user and a registration location related to the second user, a second user who is requested to purchase the product or the like.

(3-5)

The intermediate support system according to any one of descriptions (3-1) to (3-4), wherein the intermediating unit selects, from among the second users based on a relationship between action schedule of the first user and action schedule of the second user, the second user who is requested to purchase the product or the like.

(3-6)

The intermediate support system according to description (3-5), further comprising a database that receives registration of the action schedule of the second user from the terminal device used by the second user, wherein

the intermediating unit selects, from among the second users based on the action schedule of the second user registered in the database, the second user who is requested to purchase the product or the like.

(3-7)

The intermediate support system according to any one of descriptions (3-1) to (3-6), wherein the intermediating unit stores information indicating that the first user pays compensation to the second user.

(3-8)

The intermediate support system according to any one of descriptions (3-1) to (3-7), further comprising:

a first estimating unit that estimates, based on the number of visitors to the store, a remaining amount of the products or the like in the store; and

a first providing unit that provides the remaining amount estimated by the first estimating unit to the terminal device used by the first user and the terminal device used by the second user.

(3-9)

The intermediate support system according to any one of descriptions (3-1) to (3-8), further comprising:

a second estimating unit that estimates a remaining amount of the products or the like in the store based on real time data on a sales record in the store provided from a point of sale (POS) system; and

a second providing unit that provides the remaining amount estimated by the second estimating unit to the terminal device used by the first user and the terminal device used by the second user.

(3-10)

The intermediate support system according to any one of descriptions (3-1) to (3-9), further comprising a third providing unit that provides, to a terminal device used by a third user who is present in the store, an inquiry request for the product or the like requested based on the purchase request, and that provides, in accordance with reception of a response including information related to a remaining amount of the products or the like from the terminal device, the response to the terminal device used by the first user and the terminal device used by the second user.

(3-11)

The intermediate support system according to description (3-10), wherein

the user extracting unit extracts, as the second user, the user who uses the terminal device that has sent the response, and

the intermediating unit requests the user who uses the terminal device that has sent the response to purchase the product or the like based on the purchase request.

(3-12)

The intermediate support system according to description (3-10), wherein, when the third providing unit provides the response to the terminal device that is used by the first user, the intermediating unit requests, based on an operation performed on the terminal device used by the first user, the user, who uses the terminal device that has sent the response, to purchase the product or the like that are requested based on the purchase request.

(3-13)

The intermediate support system according to any one of descriptions (3-1) to (3-12), wherein the user extracting unit narrows down the second users based on a history of delivery time needed for each of the second users.

(3-14)

The intermediate support system according to any one of descriptions (3-1) to (3-12), wherein the user extracting unit narrows down the second users based on evaluation of each of the second users made by the first user.

(3-15)

The intermediate support system according to any one of descriptions (3-1) to (3-12), further comprising a user designating unit that decides a user designated by the first user as the second user, wherein

the intermediating unit requests the terminal device that is used by the second user decided by the user designating unit to purchase the product or the like.

(3-16)

An intermediate support method comprising:

receiving, from a first user, a purchase request for a product or a service sold in a store (hereinafter, referred to as the product or the like);

extracting a second user who is at least one of a user who is currently visiting the store and a user who is highly likely to visit the store; and

sending, based on the received purchase request, to a terminal device used by the extracted second user, information that requests to purchase the product or the like.

(3-17)

A non-transitory computer readable storage medium having stored therein an intermediate support program that causes a computer to execute a process comprising:

receiving, from a first user, a purchase request for a product or a service sold in a store (hereinafter, referred to as the product or the like);

extracting a second user who is at least one of a user who is currently visiting the store and a user who is highly likely to visit the store; and

sending, based on the received purchase request, to a terminal device used by the extracted second user, information that requests to purchase the product or the like.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An intermediate support system comprising:
a receiving unit that receives, from a first user, a purchase request for a product or a service sold in a store;
a user extracting unit that extracts a second user who is at least one of a user who is currently visiting the store and a user who is highly likely to visit the store; and
an intermediating unit that sends, based on the purchase request received by the receiving unit, to a terminal device used by the second user extracted by the user extracting unit, information that requests to purchase the product or the service.

2. The intermediate support system according to claim 1, wherein the user extracting unit acquires a location of the user who is currently visiting the store based on a relationship between a signal pattern detected by a geomagnetism detecting unit mounted on the terminal device used by the user and a previously registered signal pattern and extracts, based on the acquired location of the user, the user who is currently visiting the store.

3. The intermediate support system according to claim 1, wherein the user extracting unit extracts, based on action schedule of the user, the second user who is the user who is highly likely to visit the store.

4. The intermediate support system according to claim 1, wherein the intermediating unit selects, from among the second users based on a relationship between a registration location related to the first user and a registration location related to the second user, the second user who is requested to purchase the product or the service.

5. The intermediate support system according to claim 1, wherein the intermediating unit selects, from among the second users based on a relationship between action schedule of the first user and action schedule of the second user, the second user who is requested to purchase the product or the service.

6. The intermediate support system according to claim 5, further comprising a database that receives registration of the action schedule of the second user from the terminal device used by the second user, wherein
the intermediating unit selects, from among the second users based on the action schedule of the second user registered in the database, the second user who is requested to purchase the product or the service.

7. The intermediate support system according to claim 1, wherein the intermediating unit stores information indicating that the first user pays compensation to the second user.

8. The intermediate support system according to claim 1, further comprising:
a first estimating unit that estimates, based on the number of visitors to the store, a remaining amount of the products or the services in the store; and
a first providing unit that provides the remaining amount estimated by the first estimating unit to the terminal device used by the first user and the terminal device used by the second user.

9. The intermediate support system according to claim 1, further comprising:
a second estimating unit that estimates a remaining amount of the products or the services in the store based on real time data on a sales record in the store provided from a point of sale (POS) system; and
a second providing unit that provides the remaining amount estimated by the second estimating unit to the terminal device used by the first user and the terminal device used by the second user.

10. The intermediate support system according to claim 1, further comprising a third providing unit that provides, to a terminal device used by a third user who is present in the store, an inquiry request for the product or the service requested based on the purchase request, and that provides, in accordance with reception of a response including information related to a remaining amount of the products or the services from the terminal device, the response to the terminal device used by the first user and the terminal device used by the second user.

11. The intermediate support system according to claim 10, wherein
the user extracting unit extracts, as the second user, the user who uses the terminal device that has sent the response, and
the intermediating unit requests the user who uses the terminal device that has sent the response to purchase the product or the service based on the purchase request.

12. The intermediate support system according to claim 10, wherein, when the third providing unit provides the response to the terminal device that is used by the first user, the intermediating unit requests, based on an operation performed on the terminal device used by the first user, the user, who uses the terminal device that has sent the response, to purchase the product or the service that is requested based on the purchase request.

13. The intermediate support system according to claim 1, wherein the user extracting unit narrows down the second users based on a history of delivery time needed for each of the second users.

14. The intermediate support system according to claim 1, wherein the user extracting unit narrows down the second users based on evaluation of each of the second users made by the first user.

15. The intermediate support system according to claim 1, further comprising a user designating unit that decides a user designated by the first user as the second user, wherein
the intermediating unit requests the terminal device that is used by the second user decided by the user designating unit to purchase the product or the service.

16. An intermediate support method comprising:
receiving, from a first user, a purchase request for a product or a service sold in a store;
extracting a second user who is at least one of a user who is currently visiting the store and a user who is highly likely to visit the store; and
sending, based on the received purchase request, to a terminal device used by the extracted second user, information that requests to purchase the product or the service.

17. A non-transitory computer readable storage medium having stored therein an intermediate support program that causes a computer to execute a process comprising:
receiving, from a first user, a purchase request for a product or a service sold in a store;
extracting a second user who is at least one of a user who is currently visiting the store and a user who is highly likely to visit the store; and
sending, based on the received purchase request, to a terminal device used by the extracted second user, information that requests to purchase the product or the service.
